(19) United States
(12) Patent Application Publication
(10) Pub. No.: US 2007/0234233 A1
(43) Pub. Date: Oct. 4, 2007

(54) Method of shifting between viewpoints of layout edit windows

(75) Inventors: Vam Chang, Taipei (TW); Yi-Hsin Hsieh, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Inventec Corporation, Taipei (TW)

(21) Appl. No.: 11/391,846

(22) Filed: Mar. 29, 2006

(51) Int. Cl. G06F 17/00

(52) U.S. Cl. 715/815

(57) ABSTRACT

A method of shifting between viewpoints of layout edit windows includes: adjusting a display multiplier of the edit window to display a first electric element at a first coordinate in the edit window; establishing a first view point shifting command, which corresponds to the display multiplier and the first coordinate; adjusting the display multiplier of the edit window to display a second electric element at a second coordinate in the edit window; establishing a second viewpoint shifting command, which corresponds to the display multiplier and the second coordinate, and performing the first viewpoint shifting command or the second viewpoint shifting command, to display the first electric element or the second electric element in the edit window.

### BACKGROUND

1. Field of Invention

The invention relates to a method of shifting viewpoints, especially to a method of shifting between viewpoints of layout edit windows.

2. Related Art

In designing a printed circuit board (PCB), the computer aided design is one of the important jobs, which can include two major works. One is the placement process and the other is the layout process.

When a layout engineer performs a layout adjustment process, zoom in and zoom out movements between two connecting electric elements are usually undertaken for ensuring that the trace is in right connection. However, if the two electric elements are far from each other, the layout engineer must perform the zoom in and zoom out movements more times to make sure the trace is in right connection. Therefore, the layout adjustment process becomes complicated.

Please refer to Taiwan Patent No. 420799. This Taiwan patent discloses a view controlling system, which is used for controlling a displayed view in a window frame. The window frame is displayed in a computer monitor and the view shows a part of an image. The system includes: a computer connecting to the monitor for displaying the view in the window frame and for rolling the view, to show the different parts of the image according to the rolling signal; a pointer device connecting to the computer for controlling the cursor, which is displayed in the monitor, and a view controlling device mounted on the pointer device for detecting the direction indicated by a user. Among them, the pointer device produces a two dimensional rolling signal according to the detected input direction signal of every finger. Then the computer rolls the view of the window frame according to the received rolling signal from the pointer device.

Although the foregoing method may allow the user to quick roll the view of the window frame by the pointer device, it doesn't provide the storage and the set up functions of the adjusted view point. Therefore, the operation is inconvenient.

Please refer to Taiwan Patent No. 442748. This Taiwan patent discloses a method of automatically shifting the size of the window in which the size of the window can be automatically shifted by defining two different sizes of edit boxes or by identifying the current position of the cursor and the key pressed by the user, to determine what size of the edit box should be used in the program.

Although the foregoing method may adjust the size of the window according to the normal input behavior of the user, it still needs the identification step of the current position of the cursor for determining the step of shifting. Therefore it may also be inconvenient if this method is applied in the layout adjustment process.

Thus, a method of shifting between viewpoints of layout edit windows for improving the operating convenience of the layout adjustment process needs to be developed.

### SUMMARY OF THE INVENTION

According to the forgoing problems, an object of the invention is to provide a method of shifting between viewpoints of layout edit windows, which provides a viewpoint shifting command for shifting between the views of the connected first electric element and second electric element, in order to improve the efficiency of the layout adjustment process.

According to the invention, a method of shifting between viewpoints of layout edit windows includes: adjusting a display multiplier of the edit window, to display a first electric element at a first coordinate in the edit window, wherein the first coordinate is the central position of the first electric element; establishing a first view point shifting command, which corresponds to the display multiplier and the first coordinate; adjusting the display multiplier of the edit window to display a second electric element at a second coordinate in the edit window, wherein the second coordinate is the central position of the second electric element; establishing a second viewpoint shifting command, which corresponds to the display multiplier and the second coordinate, and performing the first viewpoint shifting command or the second view point shifting command to display the first electric element or the second electric element in the edit window.

According to the invention, a method of shifting between viewpoints of layout edit windows includes: adjusting a display multiplier and a set point coordinate of the edit window, to display an electric element at the set point coordinate in the edit window; establishing a current view point shifting command, which corresponds to the display multiplier and the set point coordinate; adjusting the display multiplier and the set point coordinate of the edit window, to display the next electric element at the next set point coordinate in the edit window; establishing a next viewpoint shifting command, which corresponds to the display multiplier and the next set point coordinate, and performing the current viewpoint shifting command or the next viewpoint shifting command to display the current electric element or the next electric element in the edit window.

Because the method of shifting between viewpoints of layout edit windows provides the establishments of at least one viewpoint shifting command to quick shift to the position of the next processed layout, the process of repeatedly adjusting the edit position in the conventional technique can be eliminated. Therefore, the operation efficiency can be improved.

### BRIEF DESCRIPTION OF THE DRAWINGS

The present invention will become more fully understood from the detailed description given below, which is for illustration only and thus is not limitative of the present invention, wherein:

FIG. 1A is a flow chart of the first embodiment of the method of shifting between viewpoints of layout edit windows;

FIG. 1B is a flow chart of the second embodiment of the method of shifting between viewpoints of layout edit windows;

FIG. 2A is an operation diagram of the second embodiment of the method of shifting between viewpoints of layout edit windows;

FIG. 2B is another operation diagram of the second embodiment of the method of shifting between viewpoints of layout edit windows; and

FIG. 2C is yet another operation diagram of the second embodiment of the method of shifting between viewpoints of layout edit windows.

### DETAILED DESCRIPTION

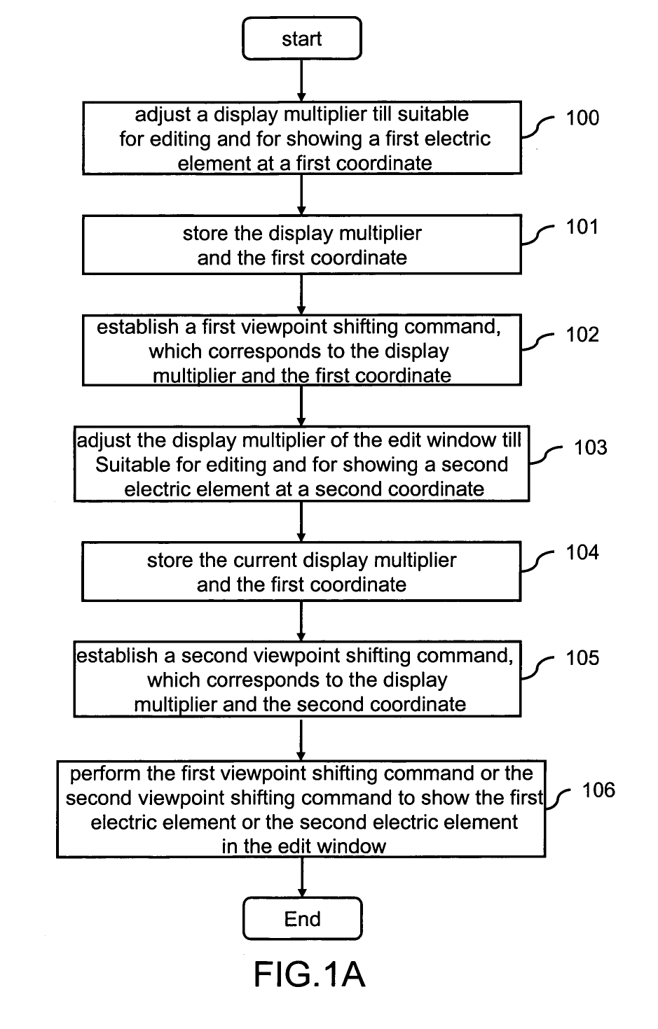

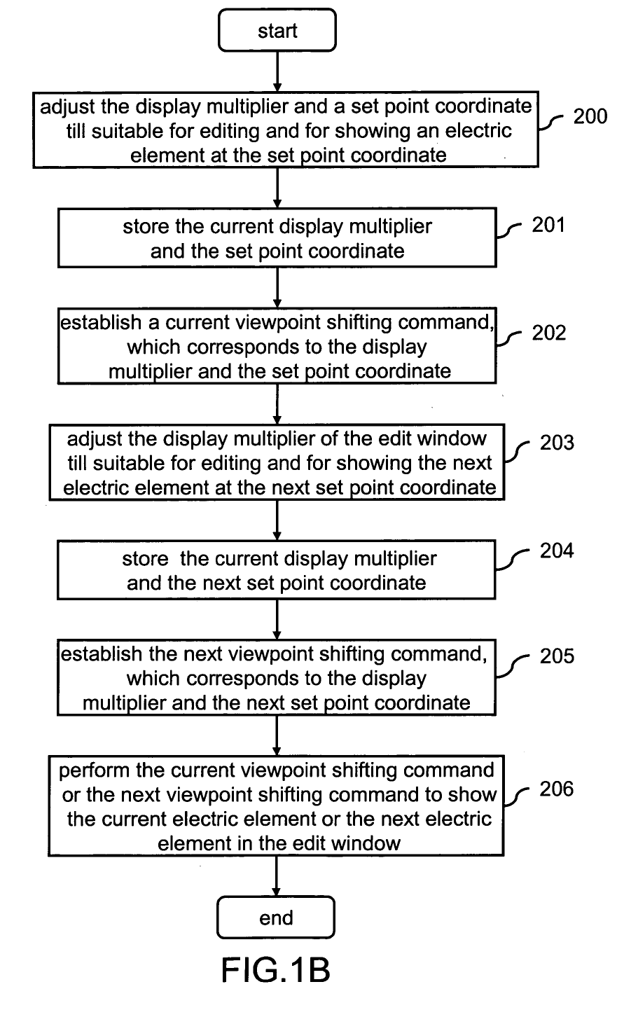

Please refer to FIG. 1A, showing a flow chart of the first embodiment of the method of shifting between viewpoints of layout edit windows, which establishes a viewpoint shifting command in the edit window, to shift views between the connected first electric element and second electric element. The method includes: adjust a display multiplier (ex: 10%, 25%, 50%, 100%, 150%, 200% or 500%) till suitable for editing and for showing a first electric element at a first coordinate (X₁, Y₁) (step 100), wherein the first coordinate is the central position of the first electric element, store the current display multiplier and the first coordinate (step 101), and establish a first viewpoint shifting command, which corresponds to the display multiplier and the first coordinate (step 102). In practice the first viewpoint shifting command can be set up to respond to a view point shifting enablement key. Therefore a layout engineer can shift the first operating viewpoint by pressing the view point shifting enablement key.

Next, further adjust the display multiplier of the edit window (ex: 10%, 25%, 50%, 100%, 150%, 200% or 500%) till suitable for editing and for showing a second electric element at a second coordinate (X₂, Y₂) (step 103), wherein the second coordinate is the central position of the second electric element. Further, store the current display multiplier and the first coordinate (step 104) and establish a second viewpoint shifting command, which corresponds to the display multiplier and the second coordinate (step 105). In practice, the second viewpoint shifting command can be set up to respond to a viewpoint shifting enablement key. Therefore a layout engineer can shift the second operating viewpoint by pressing the view point shifting enablement key.

Perform the first viewpoint shifting command or the second viewpoint shifting command to show the first electric element or the second electric element in the edit window (step 106).

Please refer to FIG. 1B, showing a flow chart of the second embodiment of the method of shifting between viewpoints of layout edit windows, which establishes at least one viewpoint shifting command in the edit window, to shift views between the connected electric elements. The method includes: adjust the display multiplier (ex: 10%, 25%, 50%, 100%, 150%, 200% or 500%) and a set point coordinate (Xₙ, Yₙ) till suitable for editing and for showing an electric element at the set point coordinate (step 200), wherein the set point coordinate can be determined by a layout engineer, designating a position in the edit window, by moving the cursor to an appropriate position and setting it up. Further, the method includes store the current display multiplier and the set point coordinate (Xₙ, Yₙ) (step 201) and establish a current viewpoint shifting command, which corresponds to the display multiplier and the set point coordinate (step 202). In practice, the current viewpoint shifting command can be set up to respond to a viewpoint shifting enablement key. Therefore, a layout engineer can shift the operating viewpoint by pressing the viewpoint shifting enablement key.

Next, further adjust the display multiplier of the edit window (ex: 10%, 25%, 50%, 100%, 150%, 200% or 500%) till suitable for editing and for showing the next electric element at the next set point coordinate (Xₙ₊₁, Yₙ₊₁) (step 203). Further, store the current display multiplier and the next set point coordinate (Xₙ₊₁, Yₙ₊₁) (step 204), and establish the next viewpoint shifting command, which corresponds to the display multiplier and the next set point coordinate (Xₙ₊₁, Yₙ₊₁) (step 205). In practice, the next viewpoint shifting command can be set up to respond to a view point shifting enablement key. Therefore, a layout engineer can shift the next operating viewpoint by pressing the view point shifting enablement key.

Perform the current viewpoint shifting command or the next viewpoint shifting command to show the current electric element or the next electric element in the edit window (step 206).

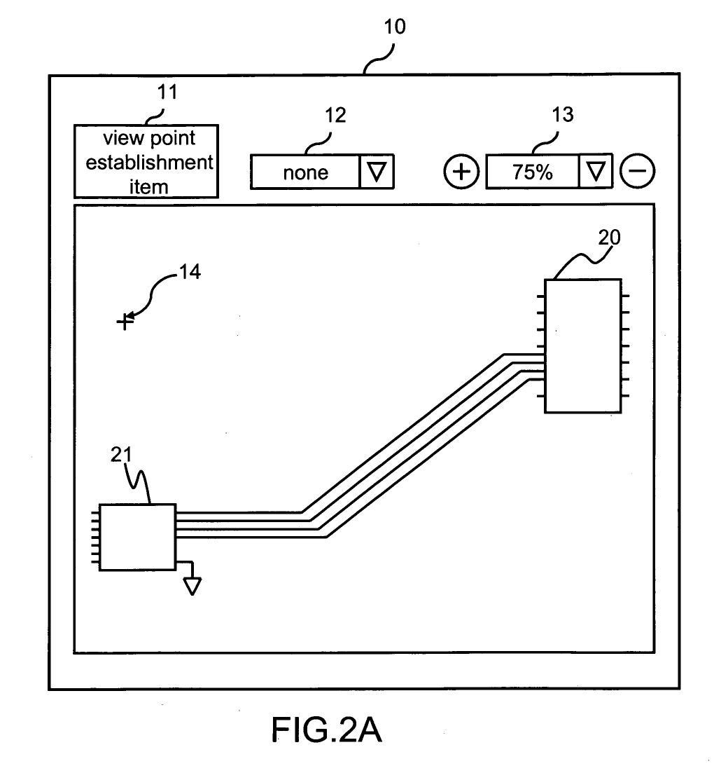

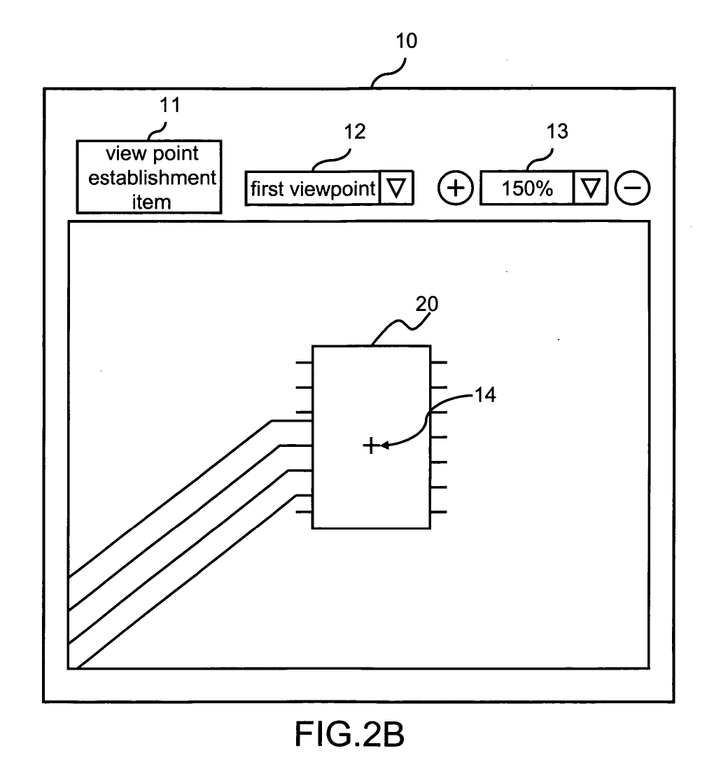

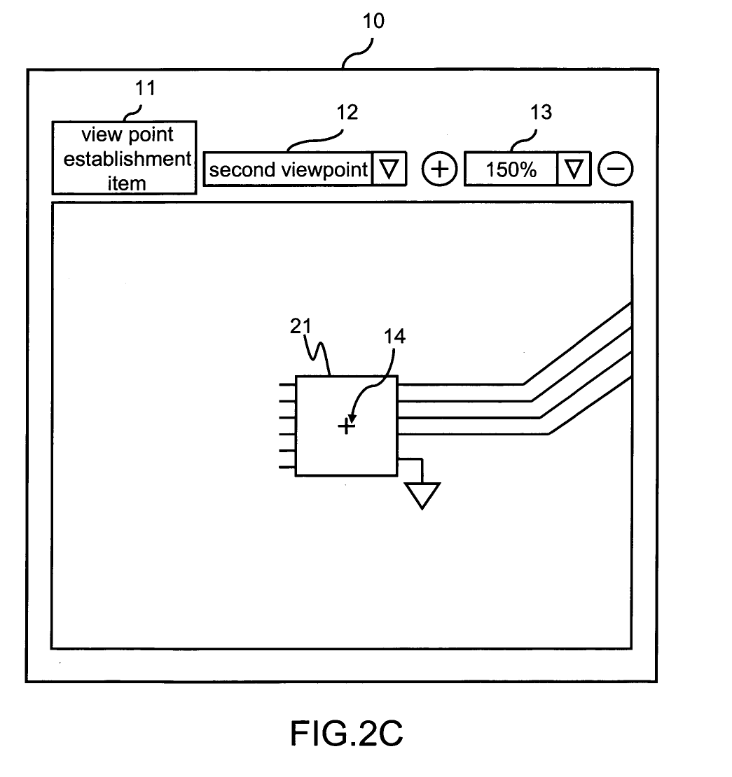

Please refer to FIG. 2A, FIG. 2B, and FIG. 2C. They show the operation diagram of the second embodiment of shifting between the viewpoints of the edit windows. A layout engineer adjusts the display multiplier in the display multiplier column 13 in the edit window 10 and moves the cursor 14 to the region that is about to undertake a layout adjustment process or element editing. Next, after the layout engineer moves the cursor 14 to the coordinate of the first electric element 20 and clicks the view point establishment item 11, the system will store the current display multiplier and the set point coordinate, which corresponds to the cursor 14. Then, after the layout engineer further moves the cursor 14 to the coordinate of the second electric element 21 and clicks the viewpoint establishment item 11 after adjusting the display multiplier, the system will store the current display multiplier and the set point coordinate, which corresponds to the cursor 14. Therefore, the layout engineer can quickly shift between the first viewpoint and the second viewpoint through the viewpoint shifting column 12 (shown in FIG. 2B and FIG. 2C), making the process of repeatedly adjusting the editing position unnecessary.

By the method of shifting between viewpoints of layout edit windows providing a viewpoint shifting command for the display multiplier and the set point coordinate, the layout engineer can quickly shift among different edit positions of different viewpoints and then undertake the related layout adjustment process. Therefore, the efficiency of the layout adjustment process can be improved.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. A method of shifting between viewpoints of layout edit windows, providing at least one view point shifting command in an edit window to shift between the views of a connected first electric elements and a second electric element, comprising:
adjusting a display multiplier of the edit window to show the first electric element at a first coordinate in the edit window;
establishing a first viewpoint shifting command which corresponds to the display multiplier and the first coordinate;
adjusting the display multiplier of the edit window to show the second electric element at a second coordinate in the edit window;
establishing a second view point shifting command which corresponds to the display multiplier and the second coordinate; and
performing the first view point shifting command or the second view point shifting command to show the first electric element or the second electric element in the edit window.

2. The method as claimed in claim 1 wherein after the step of adjusting a display multiplier of the edit window to show the first electric element at a first coordinate in the edit window further comprises a step of storing the display multiplier and the first coordinate.

3. The method as claimed in claim 1 wherein after the step of adjusting the display multiplier of the edit window to show the second electric element at a second coordinate in the edit window further comprises a step of storing the display multiplier and the second coordinate.

4. The method as claimed in claim 1 wherein the first coordinate is a central position of the first electric element.

5. The method as claimed in claim 1 wherein the second coordinate is a central position of the second electric element.

6. A method of shifting between viewpoints of layout edit windows, providing at least one view point shifting command in an edit window to shift between the views of connected electric elements, comprising:
adjusting a display multiplier and a set point coordinate of the edit window to show an electric element at the set point coordinate in the edit window;
establishing a viewpoint shifting command which corresponds to the display multiplier and the set point coordinate;
adjusting the display multiplier and the set point coordinate of the edit window to show a next electric element at a next set point coordinate in the edit window;
establishing a next viewpoint shifting command which corresponds to the display multiplier and the next set point coordinate; and
performing the viewpoint shifting command or the next view point shifting command to show the electric element or the next electric element in the edit window.

7. The method as claimed in claim 6 wherein the set point coordinate is determined according to a position of a cursor in the edit window.

8. The method as claimed in claim 6 wherein after the step of adjusting a display multiplier and a set point coordinate of the edit window to show an electric element at the set point coordinate in the edit window further comprises a step of storing the display multiplier and the set point coordinate.

9. The method of claim 6 wherein after the step of adjusting the display multiplier and the set point coordinate of the edit window to show a next electric element at a next set point coordinate in the edit window further comprises a step of storing the display multiplier and the next set point coordinate.
